(19) United States
(12) Patent Application Publication
(10) Pub. No.: US 2008/0241532 A1
(43) Pub. Date: Oct. 2, 2008

(54) Composition for Yarns, Yarns Possessing Improved Properties and Use of These Yarns

(76) Inventors: Christian Wattenhofer, Buonas (CH); Paul Schaffner, Kriens (CH)

Correspondence Address: Jean-Louis Seugnet;RHODIA INC., 8 Cedar Brook Drive, CN 7500, Cranbury, NJ, 08512-7500, US

(21) Appl. No.: 10/586,784

(22) PCT Filed: Jan. 20, 2005
(86) PCT No.: PCT/EP2005/000667

§ 371 Date: Feb. 14, 2008

(30) Foreign Application Priority Data
Jan. 22, 2004 (FR) 0400604

(51) Int. Cl. D02G 3/00; C08L 83/06

(52) U.S. Cl. 428/374; 428/391; 264/164; 525/106

(57) ABSTRACT

The invention relates to a composition for yarns, fibres or filaments which can be deposited on these yarns, fibres or filaments in order to improve the properties of these yarns, fibres or filaments, in particular the resistance to abrasion. The invention also relates to a process for producing these yarns, fibres or filaments, and also to a rope comprising these yarns, fibres or filaments, and to their use.

The invention relates to a composition for yarns, fibres or filaments which can be deposited on these yarns, fibres or filaments in order to improve the properties of these yarns, fibres or filaments, in particular the resistance to abrasion. The invention also relates to a process for producing these yarns, fibres or filaments, and also to a rope comprising these yarns, fibres or filaments, and to their use.

Ropes, cables and lines are used in many fields, such as the maritime field, the climbing field, and the like. They can, for example, be used to moor boats and ships, for example sailing vessels.

These ropes, cables and lines are subjected to high mechanical stresses when they are used, for example due to the movements of the sea, to the handling operations carried out on the rope by users, and the like. For example, a mooring rope is subjected to various stretching actions depending on the movement of the sea and boat. This produces in particular friction between the fibres of the cord, which causes abrasion of the fibres. This results in rapid wearing of these ropes, cables and lines, a reduction in the tenacity and possibly breakage.

Consequently, attempts are being made to improve the lifetime of these ropes, cables and lines, in particular by improving the properties of resistance to abrasion of the fibres of these ropes, cables and lines.

A composition to be applied to the fibres intended to prepare a rope or a cable, in order to reduce the abrasion of the fibres, is known. It is sold by Goulston Technologies under the reference Lurol NR-6025®.

The invention provides a composition which can be deposited on yarns, fibres or filaments intended, for example, to be used in a rope or a cable, the yarns, fibres or filaments of the invention exhibiting very good resistance to abrasion.

According to a first subject-matter, the invention relates to a composition which can be deposited on yarns, fibres or filaments comprising the following compounds:
a) a polyolefin chosen from the group consisting of polyethylene and polypropylene,
b) a polyorganosiloxane,
c) an ester of a copolymer obtained from an α-olefin comprising between 10 and 24 carbon atoms and from an unsaturated dicarboxylic acid.

According to a second subject-matter, the invention relates to yarns, fibres or filaments treated with the composition of the invention.

In a third subject-matter, the invention relates to a process for the preparation of these yarns, fibres or filaments comprising the following stages:
1) spinning the constituent material of the yarn,
2) optionally drawing the yarn,
3) optionally texturing the yarn, the yarn being treated using the above composition during the process.

In a fourth subject-matter, the invention relates to a rope, a cable or a line obtained from the yarns, fibres or filaments of the invention and to their use in mooring or anchoring arrangements or in the field of climbing.

The composition of the invention comprises, as compound a), a polyolefin chosen from the group consisting of polyethylene and polypropylene. Advantageously, the compound a) is a polyethylene wax. In particular, the polyethylene wax can be oxidized.

According to a specific embodiment of the invention, this compound a) is a polyethylene wax exhibiting a melting point of between 110 and 150° C., preferably of between 120 and 150° C.

Advantageously, the compound a) is a polyethylene wax exhibiting a viscosity at 150° C. of between 1000 and 5000 mPa·s.

The composition comprises, as compound b), a polyorganosiloxane. Preferably, the compound b) is a silicone oil exhibiting a viscosity at 20° C. of between 100 and 1000 mPa·s. The polyorganosiloxane can, for example, be a polymethylsiloxane or a polymethylphenylsiloxane.

The composition of the invention comprises, as compound c), an ester of a copolymer obtained from an α-olefin comprising between 10 and 24 carbon atoms and from an unsaturated dicarboxylic acid.

The ester can be obtained by esterification, using a hydroxylated compound, of the copolymer obtained from an α-olefin comprising between 10 and 24 carbon atoms and from an unsaturated dicarboxylic acid. The ester can also be obtained by addition of a monomer during the preparation of the above copolymer.

The α-olefin used to prepare the compound c) preferably comprises between 12 and 18 carbon atoms. Mention may be made, as dicarboxylic acid which can be used for the preparation of the compound c), of maleic acid, fumaric acid, itaconic acid and citraconic acid. Preferably, the dicarboxylic acid is chosen from maleic acid and fumaric acid.

The viscosity of the copolymer, measured at 40° C., is advantageously between 100 and 1000 mPa·s, preferably between 250 and 400 mPa·s.

According to a specific embodiment of the invention, the composition comprises:
x %=10 to 50% by weight of compound a), with respect to the total weight of the compounds a), b) and c) of the composition,
y %=10 to 50% by weight of compound c), with respect to the total weight of the compounds a), b) and c) of the composition,
z %=100-(x+y) % by weight of compound b), with respect to the total weight of the compounds a), b) and c) of the composition.

Advantageously, x is between 20 and 40% and y is between 20 and 40%.

The composition of the invention can be prepared according to any method known for producing a composition.

Before producing the composition, the compound a) can be in the form of an emulsion. An emulsifier can be employed during the preparation of the emulsion. Mention may be made, as example of emulsifier, of an emulsifier consisting of a fatty alcohol comprising between 10 and 20 carbon atoms, the fatty alcohol being ethoxylated and comprising 2 to 10 ethoxylates (EO).

Before producing the composition, the compound b) can be in the form of an emulsion. The emulsion can be an emulsion of the “oil-in-water” type. The compound b) advantageously represents between 10 and 60% by weight, with respect to the weight of the emulsion. An emulsifier can be employed during the preparation of the emulsion. Mention may be made, as example of emulsifier which may be suitable, of an ethoxylated fatty alcohol comprising between 10 and 20 carbon atoms and comprising 2 to 10 ethoxylates (EO).

The composition of the invention can be in the form of a solution, of an emulsion or of a dispersion in a liquid.

The composition can, for example, be in the form of a solution in an organic solvent.

The composition can also be in the form of an emulsion in a liquid, the liquid advantageously being water. When the composition is in the form of an emulsion, emulsifiers can be employed during the preparation of the composition.

When the composition is in the form of an emulsion in water, it generally comprises the compounds a), b) and c), emulsifiers and water. The portion of the composition which is not water generally comprises between 10 and 70% by weight of compounds a), b), and c) and between 30 and 90% by weight of emulsifiers. The respective proportions of the compounds a), b) and c) are the same as those described above.

According to a specific embodiment of the invention, the composition can also comprise, in addition to the compounds a), b) and c), a sizing composition.

The sizing compositions suitable for the invention are all the sizes conventionally used in the field of the spinning of polymers, in particular of the spinning of polyamides or of polyesters. The sizing compositions are usually oils or aqueous emulsions.

The composition of the invention can also comprise other compounds than the compounds a), b) and c) and optionally a sizing composition, such as surface-active agents, antistatics, which are conventionally employed in sizing compositions.

The invention relates, in a second subject-matter, to yarns, fibres or filaments treated with a composition as described above.

The yarns, fibres or filaments of the invention can be of natural, artificial and/or synthetic origin. They can also have several origins: mention may be made, by way of example, of a spun yarn of polyamide and cotton fibres.

The yarns, fibres or filaments of the invention are advantageously based on thermoplastic polymer. Mention may be made, by way of example, as thermoplastic (co)polymer suitable in the context of the invention, of polyolefins, polyesters, poly(alkylene oxide)s, polyoxyalkylenes, polyhaloalkylenes, poly(alkylene phthalate or terephthalate)s, poly(pheny or phenylene)s, poly(phenylene oxide or sulphide)s, poly(vinyl acetate)s, poly(vinyl alcohol)s, poly(vinyl halide)s, poly(vinylidene halide)s, polyvinylnitriles, polyamides, polyimides, polycarbonates, polysiloxanes, polymers of acrylic or methacrylic acid, polyacrylates or -methacrylates, natural polymers which are cellulose and its derivatives, synthetic polymers, such as synthetic elastomers, or thermoplastic copolymers comprising at least one monomer identical to any one of the monomers included in the abovementioned polymers, as well as the blends and/or alloys of all these (co)polymers.

Mention may be made, as other preferred thermoplastic polymers of the invention, of semicrystalline or amorphous polyamides, such as aliphatic polyamides, semiaromatic polyamides and more generally the linear polyamides obtained by polycondensation between an aromatic or aliphatic saturated diacid and an aliphatic or aromatic saturated di(primary amine), the polyamides obtained by condensation of a lactam or of an amino acid or the linear polyamides obtained by condensation of a mixture of these various monomers.

More specifically, these copolyamides can, for example, be poly(hexamethylene adipamide), the polyphthalamides obtained from terephthalic and/or isophthalic acid, such as the polyamide sold under the trade name Amodel, or the copolyamides obtained from adipic acid, hexamethylenediamine and caprolactam.

Advantageously, the thermoplastic polymer is a polyester, such as poly(ethylene terephthalate) (PET), poly(propylene terephthalate) (PPT), poly(butylene terephthalate) (PBT), their copolymers and blends.

More preferably still, the thermoplastic polymer is selected from the group of (co)polyamides consisting of polyamide 6, polyamide 6,6, polyamide 4, polyamide 11, polyamide 12, the polyamides 4-6, 6-10, 6-12, 6-36 and 12-12, their copolymers and blends.

The yarns, fibres or filaments of the invention can be based on a blend of thermoplastic polymers or of thermoplastic copolymers.

The yarns, fibres or filaments of the invention can comprise additives, such as reinforcing fillers, flame retardants, UV stabilizers, heat stabilizers, mattifying agents, such as titanium dioxide, bioactive agents, and the like.

The composition of the invention present at the surface of the yarn advantageously represents between 1 and 5% by weight, with respect to the weight of the yarn.

The overall count of the yarns of the invention can be chosen throughout the range of the usual counts for yarns, for example between 200 dtex and 3000 dtex. According to a specific embodiment of the invention, the yarns, fibres or filaments of the invention are yarns which exhibit an overall count of between 700 and 2500 dtex.

The strand count of the yarns of the invention can be chosen throughout the range of the usual counts for yarns. The strand count is generally greater than or equal to 0.3 dtex. It is usually less than the equivalent in dtex of a diameter of 800 microns in the case of monofilaments with a large diameter. According to a specific embodiment of the invention, the yarns, fibres or filaments of the invention are yarns which exhibit a strand count of between 3 and 9 dtex.

The invention also relates to a process for the preparation of the yarns, fibres or filaments comprising the following stages:
1) spinning the constituent material of the yarn,
2) optionally drawing the yarn,
3) optionally texturing the yarn,
4) the yarn being treated using the composition as described above during the process.

The spinning stage 1) is carried out according to any method known to a person skilled in the art.

When the material of the yarn is a thermoplastic polymer, stage 1) is advantageously a stage of melt spinning the polymer.

The yarns, fibres or filaments of the invention can be subjected to drawing. Thus, the yarn can be drawn along the spinning path according to any known process, to the degree desired according to the orientation and the mechanical characteristics which it is desired to confer on it. It can also be simply preoriented or spin-oriented according to the final winding rate. It can be obtained directly or taken up on rolls to adjust the winding tension, if this proves useful or necessary. Stage 2) may or may not be carried out integrally with the spinning.

The winding rate is generally between 400 and 8000 m/min, advantageously between 600 and 5000 m/min, preferably between 600 and 2000 m/min.

The texturing stage 3) can be carried out according to any method known to a person skilled in the art.

The treatment stage can be carried out before or after the optional drawing stage. The treatment stage can also be carried out before or after the optional texturing stage 3).

The treatment can be carried out according to standard techniques, such as roll coating or coating with spin-finish device (“gudulettes” in French language). Mention can be made, among the standard techniques, by way of example without implied limitation, of the technique for the treatment of the raw fibre with a roll, by spraying or vaporizing, by dipping, the padding technique, and any method used in the textile industry for the treatment of synthetic fibres. This treatment can be carried out at different stages in the manufacture of the yarns. They are, inter alia, all the stages where lubricating agents are conventionally added. It is thus possible to apply the additive at the bottom of the spinning frame before winding. It is also possible, in the case of “fibre” processes, to apply the additive before, during or after the drawing, crimping or drying stages, and the like.

In some cases, it can in addition be advantageous to subject the yarn to a first preliminary treatment (pretreatment) according to methods known to a person skilled in the art, in order to promote the adhesion of the grafted copolymer to the yarn. In addition, it will also be possible to envisage subjecting the yarn, before or after the treatment of the invention, to other chemical or physical treatments, such as, for example, irradiation, and others.

The yarns, fibres or filaments treated with the composition of the invention exhibit very good resistance to abrasion.

In a fourth subject-matter, the invention relates to a rope, a cable or a line comprising at least in part the yarns, fibres or filaments of the invention.

The rope, the cable or the line of the invention can be used in mooring or anchoring arrangements for boats, ships, floating landing stages, light pontoons, or anchor, navigation or marker buoys.

This is because, as the yarns, fibres or filaments of the invention exhibit high resistance to abrasion, the ropes obtained using these yarns exhibit low wear and a long lifetime, in particular when these ropes are subjected to repeated immersions in water.

The rope, the cable or the line of the invention can also be used in the field of climbing, in which ropes are subjected to high mechanical stresses. In a climbing rope, the yarns, fibres or filaments of the invention are advantageously present in the core of the rope, in contrast to the sheath, which is generally in the form of braided yarns.

The yarns, fibres or filaments of the invention can also be used in nets, such as fishing nets or safety nets. They can also be used in belts, such as safety belts.

Other details or advantages of the invention will become more fully apparent in the light of the examples given below solely by way of indication.

Test of Resistance to Abrasion of the Yarns, Fibres or Filaments

The standard used for measuring the resistance to abrasion of the yarns is Standard ASTM D 6611-00. The conditions of the standard used during the test are as follows:
Interwrapping of the test yarn: 3 revolutions (interwrapping angle:1080°)
Amplitude of the movement (stroke) of the test yarn: 6 cm
Speed of the motor: 70 revolutions/min
Tension exerted on the yarn by the weight: 445 cN

The test is carried out in accordance with the above standard under dry and wet conditions as described in the standard. The test is also carried out under the dry conditions of the standard, after a treatment of the yarn which simulates a rope immersed in water and then dried in the air. This treatment is described below.

Treatment of the Yarn which Simulates a Rope Immersed in Water and then Dried in the Air

The yarn is immersed in distilled water at ambient temperature for 10 minutes, including 1 minute with agitation of the yarn. The yarn is subsequently placed on a cotton fabric and dried in the air at ambient temperature for 24 h.

Method for Measuring the Amount of Composition Deposited on the Yarn

The composition present on the yarn is extracted in a Soxhlet-type device using petroleum ether exhibiting a boiling point between 30 and 50° C. The extraction is cyclic, the duration of the cycle being between 6 and 10 minutes. The extraction time is 1 hour. The ratio of the weight of sample to the weight of solvent is between 1/10 and 1/20. The weight of the sample is between 2 and 10 g.

### EXAMPLE

A yarn made of polyamide 6 sold by Rhodia Industrial Yarns AG under the reference T371 (1400f210: 210 filaments with an overall count of 1400 dtex) is wound off and treated by passing the yarn over a rotating roll (the yarn being placed perpendicular to the longitudinal axis of the roll), the roll being partially immersed in a bath containing a composition as described in Table 1 below. The passage of the yarn over the roll is carried out according to a conventional method. The overall rate of passage of the yarn is 450 m/min, the yarn being guided against the roll and the guide carrying out a to-and-fro movement along the direction of the longitudinal axis of the roll, in order to optimize the deposition of the composition on the yarn.

TABLE 1

| | | Amount of | Dry | Wet | Dry conditions |
|---|---|---|---|---|---|
| | | composition | conditions: | conditions: | after treatment: |
| | | present on | time before | time before | time |
| | | the yarn by | breaking | breaking | before |
| Example | Composition | weight (%) | (min) | (min) | breaking (min) |
| Comparative A | None | — | 2 | 32 | 2 |
| Comparative B | Composition 1 | 2.9 | 235 | 92 | 394 |
| 1 | Composition 2 | 3.1 | 413 | 125 | 631 |

Composition 1: Emulsion comprising 25% by weight of Lurol NR-60250®, sold by Goulston Technologies, in water

Composition 2 (the percentages are expressed by weight with respect to the total weight of the composition ): Emulsion comprising:
9% of oxidized polyethylene wax (compound a)) with a melting point of 140° C.
2.6% of emulsifier of the ethoxylated fatty alcohol comprising 13 carbon atoms and comprising 6 ethoxylates (EO) type, this emulsifier originating from an emulsion of the above polyethylene wax before preparation of the composition
6.5% of silicone oil (compound b)) exhibiting a viscosity at 20° C. of 350 mPa·s, originating from an “oil-in-water” emulsion of this silicone oil before preparation of the composition, the emulsion comprising 10% by weight of an emulsifier of the ethoxylated fatty alcohol comprising 13 carbon atoms and comprising 6 ethoxylates (EO) type
9% of an ester of a copolymer obtained from an α-olefin and from a mixture of maleic acid and of fumaric acid, the copolymer exhibiting a viscosity at 40° C. of 340 mPa·s, measured according to Standard ASTM D-445
9% of emulsifier of the hydrated castor oil comprising between 5 and 30 ethoxylates (EO) type
9% of emulsifier of the ethoxylated fatty amine comprising between 6 and 20 carbon atoms and comprising 10 ethoxylates (EO) type
54.9% of deionized water.
   This emulsion is diluted with distilled water in a 1/1 ratio before application to the yarn.

The yarn treated according to the invention exhibits very good resistance to abrasion in comparison with an untreated yarn or with a yarn treated according to the prior art, whether under dry conditions, under wet conditions or under dry conditions after a treatment which simulates the immersion of a rope in water.

1-22. (canceled)

23. A composition comprising:
a) a polyolefin selected from the group consisting of polyethylene and polypropylene,
b) a polyorganosiloxane, and
c) an ester of a copolymer obtained from an α-olefin comprising between 10 and 24 carbon atoms and from an unsaturated dicarboxylic acid.

24. The composition according to claim 1, wherein the compound a) is a polyethylene wax.

25. The composition according to claim 23, wherein the compound a) is a polyethylene wax exhibiting a melting point of between 110 and 150° C., optionally of between 120 and 150° C.

26. The composition according to one claim 23, wherein the compound b) is a silicone oil exhibiting a viscosity at 20° C. of between 100 and 1000 mPa·s.

27. The composition according to claim 23, comprising:
x %=10 to 50% by weight of compound a), with respect to the total weight of the compounds a), b) and c) of the composition,
y %=10 to 50% by weight of compound c), with respect to the total weight of the compounds a), b) and c) of the composition, and
z %=100−(x+y) % by weight of compound b), with respect to the total weight of the compounds a), b) and c) of the composition.

28. The composition according to claim 27, wherein x is between 20 and 40% and y is between 20 and 40%.

29. The composition according to claim 23, further comprising a sizing composition.

30. The composition according to claim 23, being in the form of an emulsion in a liquid.

31. The composition according to claim 30, wherein the liquid is water.

32. Yarns, fibres or filaments, treated with a composition as defined in claim 23.

33. The yarns, fibres or filaments according to claim 32, being based on thermoplastic polymer.

34. The yarns, fibres or filaments according to claim 33, being based on polyester or on polyamide.

35. The yarns, fibres or filaments according to claim 32, wherein the composition present at the surface of the yarn represents between 1 and 5%, with respect to the weight of the yarn.

36. The yarns, fibres or filaments according to claim 23, wherein the yarns exhibit an overall count of between 700 and 2500 dtex.

37. The yarns, fibres or filaments according to claim 23, wherein the yarns exhib a strand count of between 3 and 9 dtex.

38. A process for the preparation of yarns, fibres or filaments as defined in claim 32 comprising the following stages:
1) spinning the constituent material of the yarn,
2) optionally drawing the yarn,
3) optionally texturing the yarn, and
4) treating the yarn is treated with a composition as defined in claim 23.

39. The process according to claim 38, wherein the material is a thermoplastic polymer and stage 1) is a melt spinning of the polymer.

40. The process according to claim 38, wherein the treatment stage 4) is carried out after stages 2) and 3).

41. The process according to claim 38, wherein the treatment stage 4) is carried out before stages 2) and 3).

42. A rope, cable or line, wherein it comprises at least yarns, fibres or filaments according to claim 32.

43. A mooring or anchoring arrangements for boats, ships, floating landing stages, light pontoons, or anchor, navigation, climbing tool or marker buoys comprising a rope, cable or line as defined in claim 42.
